(19) United States
(12) Patent Application Publication
(10) Pub. No.: US 2014/0092439 A1
(43) Pub. Date: Apr. 3, 2014

(54) ENCODING IMAGES USING A 3D MESH OF POLYGONS AND CORRESPONDING TEXTURES

(71) Applicant: Scott A. Krig, Santa Clara, CA (US)

(72) Inventor: Scott A. Krig, Santa Clara, CA (US)

(21) Appl. No.: 13/630,816

(22) Filed: Sep. 28, 2012

(51) Int. Cl. H04N 13/00; G06K 15/02

(52) U.S. Cl. CPC H04N 13/0048; G06K 15/181
USPC 358/2.1; 348/43

(57) ABSTRACT

A method and system for encoding images using a 3D mesh of polygons and corresponding textures is disclosed herein. Depth information and image texture information may be obtained, and the 3D mesh of polygons may be calculated from the depth information. The corresponding textures may be determined using the image texture information, and both the 3D mesh of polygons and the corresponding textures may be encoded using at least one of a mesh frame, a texture frame, a change frame, or any combinations thereof.

### TECHNICAL FIELD

The present invention relates generally to encoding. More specifically, the present invention relates to the encoding depth information.

### BACKGROUND ART

During image capture, there are various techniques used to capture depth information associated with the image texture information. The depth information is typically used to produce a point cloud or a depth map with a three dimensional (3D) polygonal mesh that defines the shape of 3D objects within the image.

The raw or unprocessed depth information may be captured by a camera, and then sent to a processing unit for further processing. The depth information may be sent to the processing unit in any of a variety of formats. The depth information may also be derived from 2D images using stereo pairs or multi-view stereo reconstruction methods. Further, the depth information may be derived from a wide range of direct depth sensing methods including structured light, time of flight sensors, and many other techniques.

After processing, the depth Information may be represented in several formats, including but not limited to, an X, Y, and Z point cloud in a 3D space, a 2D depth map image, or a 3D surface mesh of triangles or quadrilaterals. Other formats for representing depth information include an XML encoded format, a textual format, or a graphical format such as OpenGL.

### BRIEF DESCRIPTION OF THE DRAWINGS

FIG. 1 is a block diagram of a computing device that may be used in accordance with embodiments;

FIG. 2A is a polygonal mesh, in accordance with embodiments;

FIG. 2B is a polygonal mesh with textures applied, in accordance with embodiments;

FIG. 3 is a process flow diagram showing a method for rendering 3D images, in accordance with embodiments;

FIG. 4 is a diagram of the data stored in an M-frame, T-frame, and C-frame, in accordance with embodiments;

FIG. 5 is a sequence of frames, in accordance with embodiments;

FIG. 6 is a process flow diagram showing a method for encoding images using a mesh and textures, in accordance with embodiments;

FIG. 7 is a block diagram showing tangible, non-transitory computer-readable media that stores code for encoding images using a mesh and a corresponding texture, in accordance with embodiments;

FIG. 8 is a block diagram of an exemplary system for encoding images using a 3D mesh of polygons and corresponding textures, in accordance with embodiments;

FIG. 9 is a schematic of a small form factor device 900 in which the system of FIG. 8 may be embodied, in accordance with embodiments; and

FIG. 10 is a process flow diagram illustrating a method for printing an image encoded using a 3D mesh of polygons and corresponding textures in a printing device, in accordance with embodiments.

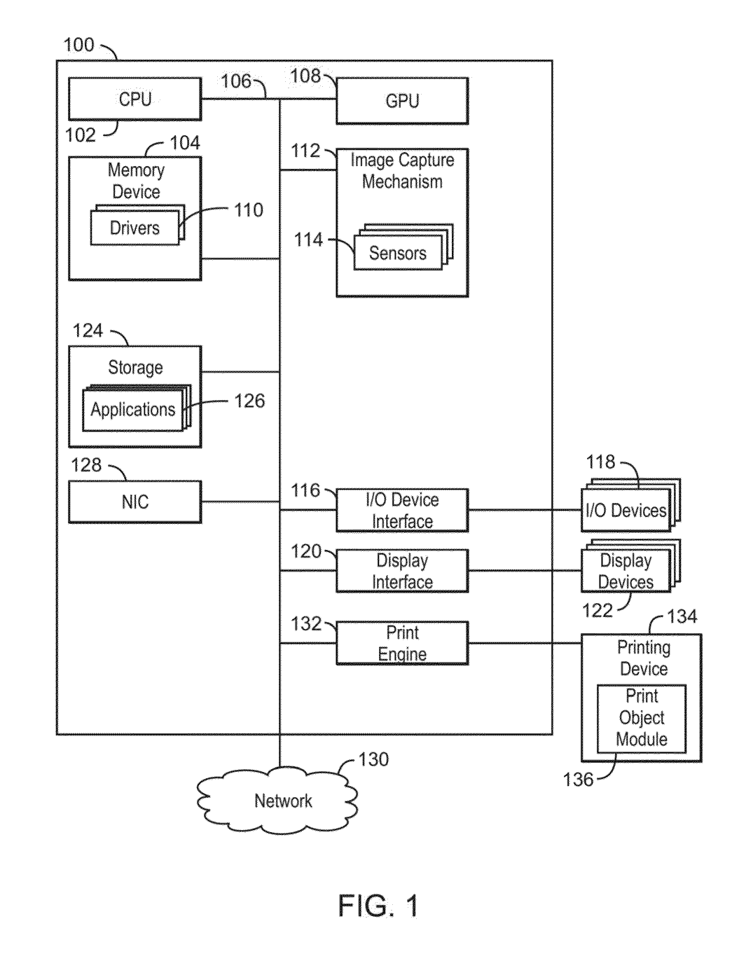

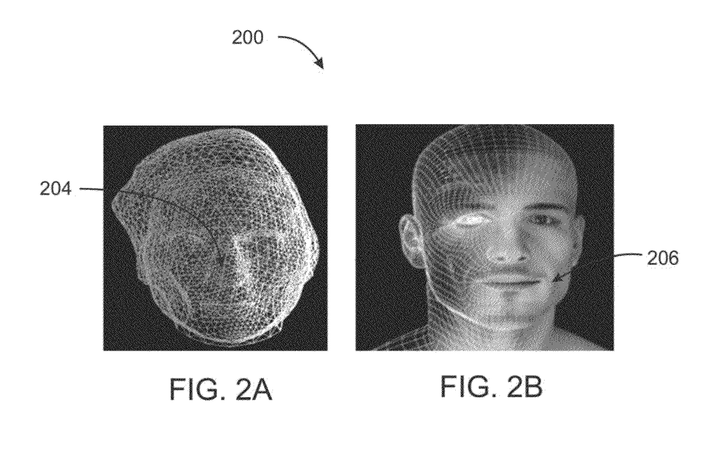

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, depth information may be sent to a processing unit for further processing along with the associated image texture information. In embodiments, any technique to extract the depth information may be used. The depth information may be sent to the processing unit in any of a variety of formats. For example, structured light patterns may be broadcast into a scene, and the depth information may be reconstructed by detecting the size of the patterns, as the structured light patterns change with distance. In other examples, a time of flight (TOF) sensor may be used to gather information by measuring the round trip time of flight of an infrared light from the sensor, to an object, and back.

As discussed above, the depth information may also be derived from 2D images using stereo pairs or multi-view stereo reconstruction methods, or the depth information may be derived from a wide range of direct depth sensing methods including structured light, time of flight sensors, and many other methods. However, current 2D image capturing systems do not produce a depth map. Furthermore, the depth information is not standardized. The lack of a standardized method of sending depth information and the associated image texture information can prevent the use of depth information in a variety of applications. Accordingly, embodiments described herein relate to encoding depth information and the associated image texture information. The encoded information may be used with any media CODEC format. By encoding the information in conjunction with standard media CODEC formats, the fusion of real video images with synthetic 3D graphics is enabled.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage, media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may be used in accordance with embodiments. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to encode images using a 3D mesh of polygons and corresponding textures.

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines (not shown), wherein each graphics engine is configured to perform specific graphics tasks, or to execute specific types of workloads.

The memory device 104 can include random access memory (RAM), read only memory (ROM), flash memory, or any other suitable memory systems. For example, the memory device 104 may include dynamic random access memory (DRAM). The memory device 104 may include a device driver 110 that is configured to execute the instructions for encoding depth information. The device driver 110 may be software, an application program, application code, or the like.

The computing device 100 includes an image capture mechanism 112. In embodiments, the image capture mechanism 112 is a camera, stereoscopic camera, infrared sensor, or the like. The image capture mechanism 112 is used to capture depth information and image texture information. Accordingly, the computing device 100 also includes one or more sensors 114. In examples, a sensor 114 may be a depth sensor that is used to capture the depth information associated with the image texture information. A sensor 114 may also be an image sensor used to capture image texture information. Furthermore, the image sensor may be a charge-coupled device (CCD) image sensor, a complementary metal-oxide-semiconductor (CMOS) image sensor, a system on chip (SOC) image sensor, an image sensors with photosensitive thin film transistors, or any combination thereof. The device driver 110 may encode the depth information using a 3D mesh and the corresponding textures from the image texture information in any standardized media CODEC, currently existing or developed in the future.

The CPU 102 may be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. The I/O devices 118 may be built-in components of the computing device 100, or may be devices that are externally connected to the computing device 100.

The CPU 102 may also be linked through the bus 106 to a display interface 120 configured to connect the computing device 100 to a display device 122. The display device 122 may include a display screen that is a built-in component of the computing device 100. The display device 122 may also include a computer monitor, television, or projector, among others, that is externally connected to the computing device 100.

The computing device also includes a storage device 124. The storage device 124 is a physical memory such as a hard drive, an optical drive, a thumbdrive, an array of drives, or any combinations thereof. The storage device 124 may also include remote storage drives. The storage device 124 includes any number of applications 126 that are configured to run on the computing device 100. The applications 126 may be used to combine the media and graphics, including 3D stereo camera images and 3D graphics for stereo displays.

In examples, an application 126 may be used to encode the depth information and image texture information. Further, in examples, an application 126 may combine real video images with synthetic 3D computer generated images. The combined media stream or file may be processed by encoding the media stream or file, then decoding the media stream or file for rendering. Further, an application 126 may be used to decode media within a standard graphics pipeline using vertex and texture units. Moreover, an application 126 may be used to introduce an “avatar” into real video scenes at runtime. As used herein, an avatar may be a synthetic human image. In embodiments, other 3D objects may be substituted into 3D videos. In embodiments, light sources may be added into the media stream in real time. Various aspects of the light source may be changed, including but not limited to, position, color and distance of the lighting. Accordingly, an encoded mesh and the corresponding textures may be altered with at least one of an addition of synthetic images, lighting, shading, object substitution, avatar introduction, or any combinations thereof.

The computing device 100 may also include a network interface controller (NIC) 128 may be configured to connect the computing device 100 through the bus 106 to a network 130. The network 130 may be a wide area network (WAN), local area network (LAN), or the Internet, among others.

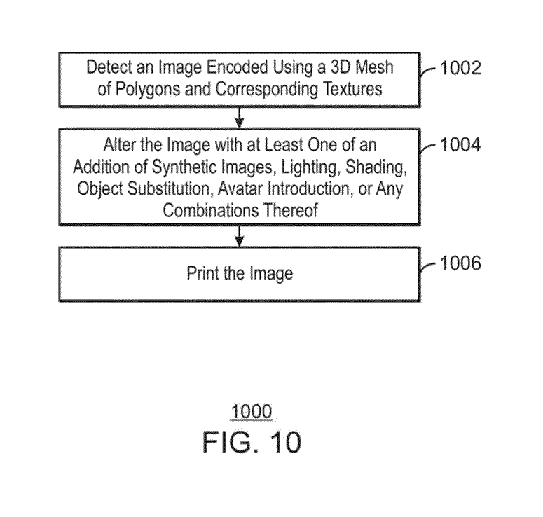

In some embodiments, an application 126 can send the encoded 3D mesh of polygons and corresponding textures to a print engine 132 that can send the encoded 3D mesh of polygons and corresponding textures to a printing device 134. The printing device 134 can include printers, fax machines, and other printing devices that can print the encoded 3D mesh of polygons and corresponding textures using a print object module 136. The print object module is discussed in greater detail in relation to FIG. 10. In embodiments, the print engine 132 may send data to the printing device 134 across the network 130.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

When a two dimensional (2D) video is encoded, a motion estimation search may be performed on each frame in order to determine the motion vectors for each frame. As used herein, a frame is one of a time sequence of frames in the video stream where each frame may be captured at intervals over a sequence of time. For example, the frames may be displayed at 30 frames per second, 60 frames per second, or whatever frame rate and sample interval is needed. The frame rate can be specified by the encoding format of the video stream. When the video stream is played, each frame is rendered on a display for a short period of time. Motion estimation is a technique in which the movement of objects in a sequence of frames is analyzed to obtain vectors that represent the estimated motion of the object between frames. Through motion estimation, the encoded media file includes the parts of the frame that moved without including other portions of the frame, thereby saving space in the media file and saving processing time during decoding of the media file. The frame may be divided into macroblocks, and the motion vectors represent the change in position of a macroblock between frames. A macroblock is typically a block of pixels. For example, a macroblock could be sixteen by eight pixels in size.

A 2D motion estimation search typically involves performing coarse searches for motion vectors for each frame to determine an estimated motion vector for each macroblock within the frame. The initial estimated motion vectors may be refined by performing additional searches at a finer level of granularity. For example, the macroblocks may be searched at various resolutions, from coarse to fine levels of granularity, in order to determine the motion vectors. Other motion estimation searching techniques may include, but are not limited to, changing the size of the macroblocks when searching for motion vectors.

Once the motion vectors and macroblock types have been determined through a motion estimation search on a 2D frame, bit rate control may be applied to each frame in order to create frames that meet the frame size of the encoding format of the target 2D video stream. The various video compression formats use a stated bit rate for a video stream, and the bit rate is the number of bits per second that are present when the video is played. Video encoding formats include, but are not limited to, H.264, MPEG-4, and VC-1. The frames may be sized in such a manner that the number of bits per frame comports with the bit rate of the encoding format of the target video stream. An encoder may perform motion estimation again on the 2D media stream to determine the finer motion vectors and macroblock types of the frames after the bit rate control has been applied to each frame. Once new motion vectors and macroblock types have been determined, the 2D frames may be encoded in to a final compressed video stream in the target video compression format.

The 2D frames may be encoded as intra-coded frames (l-frames), predictive picture frames (P-frames), or bi-directional predicted picture frames (B-frames). When a frame is encoded using I-frames, each individual frame is fully specified within the encoding. Thus, an I-frame conveys the entire image texture information without use of data from the previous frames. Each l-frame can be thought of as a complete static image of the media encoding. When a frame is encoded using P-frames, the changes between the current frame and the previous frame are encoded. The unchanged pixels of the image are not encoded, and the frame relies on some image texture information from the previous frames when the frame is encoded. When the frame is encoded using a B-frame, the changes that occur in each frame when compared to both the previous frame and the following frame are encoded. The frames of a video stream may be referred to as a group of pictures (GOP). Each GOP can contain various combinations of I-frames, P-frames, and B-frames. Further, a video compression format may specify a frame sequence in order to comply with that format. Accordingly, a when a video stream is encoded, the resulting GOP may include I-frames, P-frames, and B-frames in various combinations.

The various combinations of l-frames, P-frames, and B-frames do not include any depth information associated with the image. Accordingly, the l-frames, P-frames, and B-frames are not used to encode stereo image texture information. In embodiments, a standardized method of encoding depth and stereo image texture information is provided, which generally includes the 3D depth information and the associated image texture information. The stereo image texture information may be obtained from a time of flight sensor, stereo camera, radial image, or the like. The 3D depth information and the associated image texture information may be encoded using a 3D polygonal mesh and the corresponding texture information according to embodiments.

FIG. 2A is a polygonal mesh, in accordance with embodiments. The polygonal mesh includes vertices, lines, edges, and faces that are used to define the shape of a 3D object. For ease of description, the techniques described herein are described using a triangular mesh. However, any type of mesh may be used in accordance with the present techniques. For example, the mesh may be a quadrilateral mesh or triangular mesh. Further, alternative depth formats may also be used in accordance with embodiments. For example, since a mesh is composed of points within a 3D space, the depth information may also be considered a 3D point cloud. Furthermore, the mesh may be encoded as a depth map in a 2D array where the array values indicate the depth of each point.

The triangular mesh 200 includes a plurality of control points, such as control point 204. A control point is a position within the triangular mesh 200 that includes corresponding information such as color, normal vectors and texture coordinates. The texture coordinates may be used to link the control point to texture information, such as a texture map. The texture information adds details, colors, or image texture information to the triangular mesh 200.

FIG. 2B is a polygonal mesh with textures applied, in accordance with embodiments. The triangular mesh 200 shows the form of a human face when the textures 206 have been applied to an illustrative triangular mesh similar to the triangular mesh shown in FIG. 200. Although the triangular mesh 200 and the corresponding textures 206 have been described in the context of rendering a 3D image, 2D images may also be rendered using the present techniques. In any event, rendering an image using polygonal meshes and corresponding textures may be accomplished using a graphics pipeline in conjunction with a standard graphics or media encoding format such as OpenGL, DirectX, H.264, MPEG-4, and VC-1.

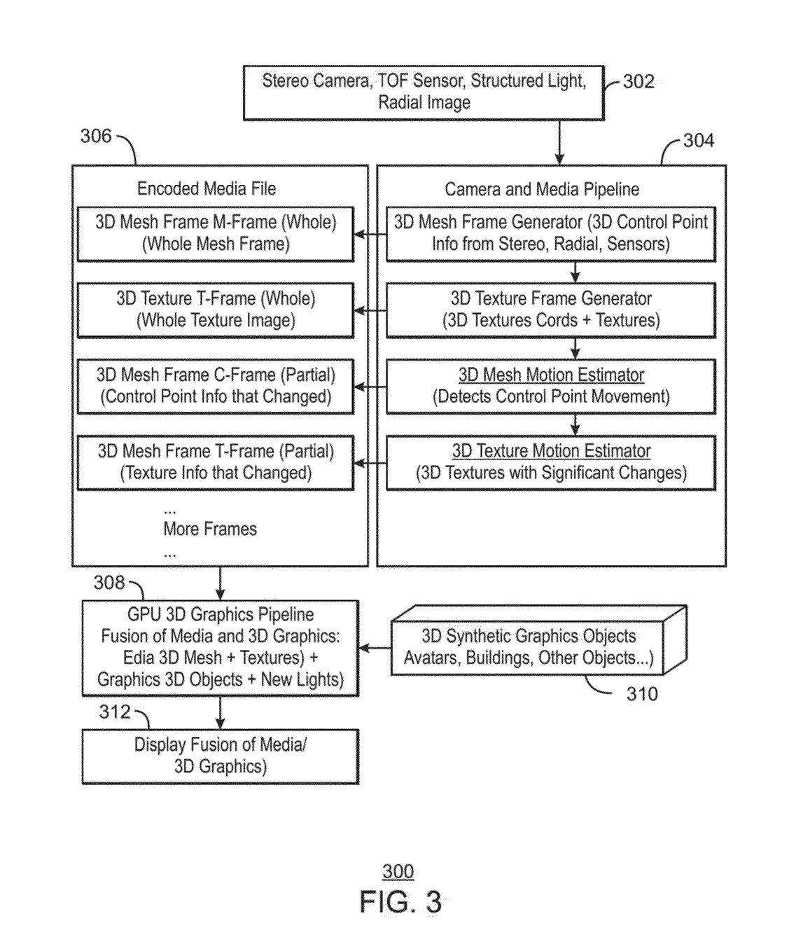

FIG. 3 is a process flow diagram 300 showing a method for rendering 3D images, in accordance with embodiments. At block 302, depth information and texture information is obtained using an image capture mechanism. The image capture mechanism may include, but is not limited to, a stereo camera, time of flight sensor, depth sensor, structured light camera, multi-view reconstruction of depth from motion of standard 2D image frames, or a radial image.

At block 304, a camera and media pipeline is used to process the 3D depth information and the associated image texture information. In embodiments, the camera and media pipeline is used to produce the 3D polygonal mesh and associated image texture information. A mesh frame (M-frame) may be generated from the polygonal mesh. The M-frame may capture the polygonal mesh information associated with the frame of the video stream. The M-frame may include, among other things, control points and the associated texture coordinates. A 3D mesh motion estimator may be used to detect changes in the coordinates of the control points. A control point is a position or coordinate within a mesh, such as the triangular mesh 200 (FIG. 2) that includes corresponding information such as color, normal vectors and texture coordinates. Through motion estimation, vectors may be obtained that represent the estimated motion of the control points between frames.

A texture frame (T-frame) may be generated from the associated image texture information that is produced using the camera and media pipeline. The T-frame includes texture coordinates as well as texture information such as details, colors, or image texture information associated with a frame of the video stream. A texture is a part of the image which may be shaped as a triangle, quadrilateral, or other polygon shape, according to various embodiments. The control points may define the vertexes of the image or the location of the polygon. A 3D texture motion estimator may be used to detect changes in the texture information, such as changes in lighting or color. Through motion estimation, vectors may be obtained that represent the estimated motion of the texture information between frames, where the motion is contained within individual polygons bounding the textures. Thereby, the textures within polygons which changed are encoded, without encoding the unchanged textures as they have not changed. Through motion estimation, texture information may be obtained that represents the estimated motion or change of the textures between frames.

A change frame (C-frame) may be generated when the change detected by the 3D mesh motion estimator or the 3D texture motion estimator is within a predetermined range. The C-frame may be referred to as a partial M-frame or a partial T-frame. In embodiments, if the motion vectors representing the estimated motion of the control points between two frames are a slight offset from one coordinate to another, the change between the two frames may be stored in a C-frame. Additionally, in embodiments, if the percentage of control points that have moved between two frames is within pre-determined range, the change between the two frames may be stored in a C-frame. The motion vectors representing the estimated motion or changes of textures between two frames may be analyzed in a similar manner in order to determine if a C-frame can be used to store the changed texture information. The predetermined range that is used to specify whether an M-frame, T-frame, or C-frame is generated may be determined based on the requirements of a CODEC or video encoding format or the performance capabilities of a device or network, allowing the motion estimation and encoding to be tuned for the power and performance goals and capabilities of a system. Further, the predetermined range may be determined based on the desired image quality, limitations on the size of the resulting video stream, the storage capacity of the computing device, or network bandwidth.

At block 306, an M-frame, T-frame, or C-frame is encoded for each frame of the 3D video stream. The video stream may include various combinations of M-frames, T-frames, and C-frames. As noted above, the type of each frame that is encoded may be dependent on the motion that occurs within the 3D video stream.

At block 308, a graphics pipeline may be used to combine the encoded 3D stream with synthetic graphics objects at block 310, where synthetic graphics is composed in standard graphical formats such as OpenGL or DirectX. The graphics pipeline may be any graphics pipeline that is currently available or developed in the future. For example, the graphics pipeline may be used to combine the encoded 3D video stream with synthetic 3D computer generated images. Additionally, the graphics pipeline may be used to add light sources to the encoded 3D video stream. At block 312, the combined video stream is rendered on a display.

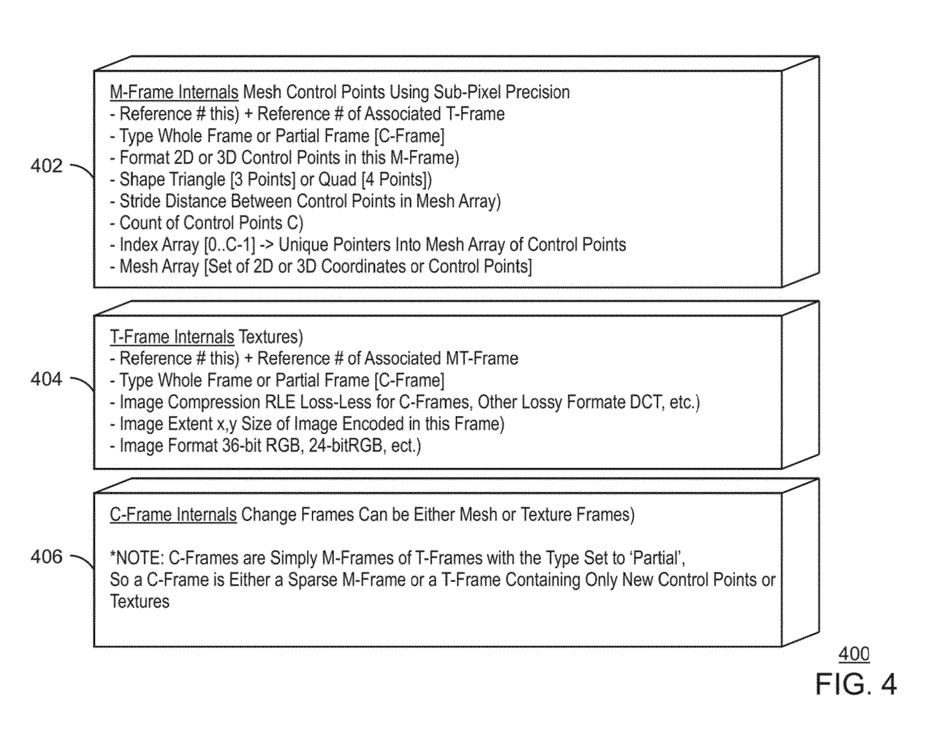

FIG. 4 is a diagram of the data stored in an M-frame, T-frame, and C-frame, in accordance with embodiments. An M-frame 402 is shown that describes the information included in an M-frame. A fully specified M-frame 402 may include any information related to the polygonal mesh. As used herein, specified refers to the information that is stored for each type of frame. In embodiments, the M-frame 402 includes reference numbers. The reference number may identify the M-frame 402 and its order in a sequence of frames. The M-frame 402 may also include the reference number of the corresponding T-frame that includes the texture information for the M-frame 402. In embodiments, the M-frame 402 may use texture coordinates to reference its corresponding T-frame.

The M-frame 402 may also include information regarding the frame type. If the M-frame 402 is a whole frame, then the frame includes the entire mesh information for the frame. If the M-frame 402 is a partial frame, then the frame is a C-frame and includes the changed mesh information between the present frame and the previous frame. Also included with the M-frame 402 is a format of the M-frame. The M-frame 402 may include 20 or 30 control points, depending on the type of video stream encoded.

The shape of the polygonal mesh may also be specified by the M-frame 402. Any polygonal shape may be used for the mesh. For example, each polygonal mesh may have three control points, making the resulting mesh a triangular mesh. In other examples, the polygonal mesh may have four control points, making the resulting mesh a quadrilateral mesh. In embodiments, other polygon meshes may be used. The M-frame 402 may also specify a structured mesh array of control points, the stride of the control points in the mesh array, and the count of the control points. A corresponding index array may also be specified with the M-frame 402.

A T-frame 404 may include a reference number, similar to the M-frame 402. The reference number may apply to the T-frame 404 itself. The T-frame 404 may also include the reference number of the corresponding M-frame that includes the mesh information for the T-frame. In embodiments, the T-frame 404 may use texture coordinates to reference its corresponding M-frame. The T-frame 404 may also include information regarding the frame type. If the T-frame 404 is a whole frame, then the frame includes the entire texture information for the frame. If the T-frame 404 is a partial frame, then the frame includes the changed texture information between the present frame and the previous frame, and is a C-frame. Additionally, the T-frame may include any information regarding the texture.

The T-frame 404 may also specify the image compression, image extent, and image format of the image texture information specified by the T-frame. The image compression may use run-length encoding (RLE) in order to enable lossless encoding for C-frames. Using RLE compression, when data runs occur, the data runs may be stored as a single data value as opposed to a string of repetitive data values. Additionally, other lossy compression formats may be used to compress the image texture information within a C-frame. The image extent may be used to specify the size of the image encoded by the T-frame 404. The image format may specify the type of image format, such as a 36-bit RGB format or a 24-bit RGB format. Although compression is described using T-frames, in embodiments, compression may be used for T-frames, M-frames, or C-frames.

A C-frame 406 may be defined as a partial M-frame or a partial T-frame, or any combinations thereof. Accordingly, the C-frame 406 may include new or changed control points if it is a partial M-frame. The C-frame 406 may also include new or changed textures if it is a partial T-frame. Furthermore, the C-frame may contain any combination of new or changed control points or new or changed textures.

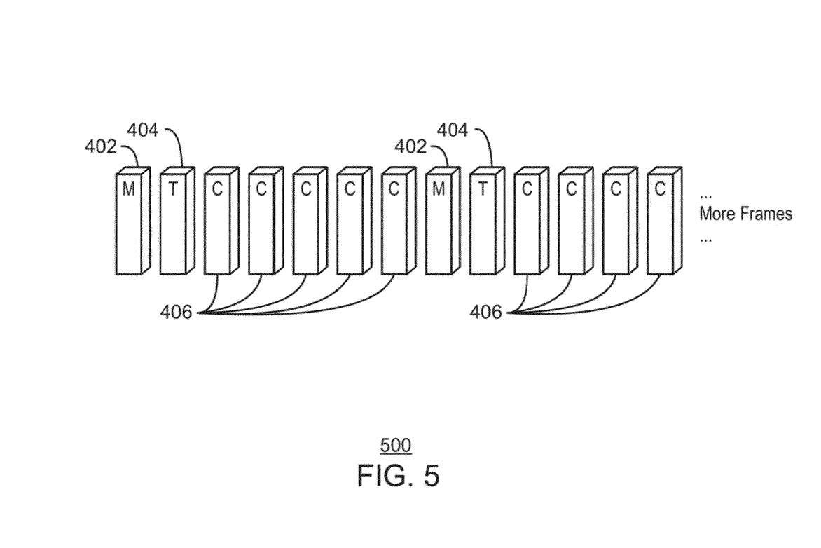

FIG. 5 is a sequence of frames 500, in accordance with embodiments. The sequence of frames 500 includes two M-frames 402, two T-frames 404, and several C-frames 406. As described above, the M-frames 402 and the T-frames 404 may fully specify the mesh and texture information in a video stream. The following C-frames 406 may specify the changes in the mesh, texture information, or any combinations thereof. If the change in the next frame in a sequence of frames is not within a predetermined range or above a threshold, the mesh or texture information may be fully specified using an M-frame car a T-frame, respectively. If the change in the next frame in a sequence of frames is not within a predetermined range or is below a threshold, the changes may be specified using a C-frame. The predetermined range or threshold may be determined based on the desired image quality, limitations on the size of the resulting 3D video stream, the storage capacity of the computing device, or network bandwidth.

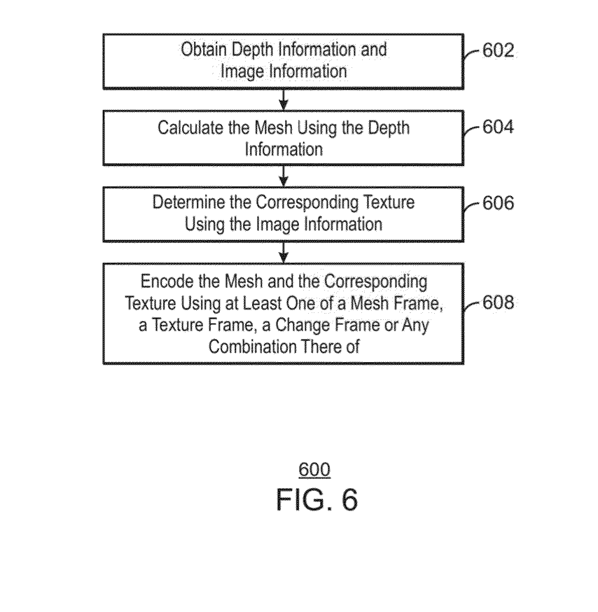

FIG. 6 is a process flow diagram showing a method 600 for encoding images using a mesh and textures, in accordance with embodiments. In various embodiments, the method 600 is used to provide a standardized encoding for depth information and the associated image texture information. In some embodiments, the method 600 may be executed on a computing device, such as the computing device 100.

At block 602, depth information and image texture information is obtained. The depth information and image texture information may be obtained or gathered using an image capture mechanism. In embodiments, any image capturing mechanism may be used. The image capture mechanism may include, but is not limited to, a stereo camera, time of flight sensor, depth sensor, structured light camera, a radial image, a 2D camera time sequence of images computed to create a multi-view stereo reconstruction, or any combinations thereof. In embodiments, the depth information and image texture information may be obtained by a device without a processing unit or storage.

At block 604, a 3D mesh of polygons is calculated from the depth information. Although one mesh of polygons is described, the depth information may be used to compute a plurality of meshes for each frame. In embodiments, the 3D mesh of polygons may be a triangular mesh, a quadrilateral mesh, a 3D point cloud, a 2D depth map array, an XML encoded format, a textual format, a graphical format such as OpenGL, any other reasonable format, or any combinations thereof. At block 606, the textures that correspond to the mesh may be determined using the image texture information. In embodiments, the corresponding texture includes details, colors, and other image texture information that corresponds to the mesh.

At block 608, the 3D mesh of polygons and the corresponding textures are encoded using at least one of a mesh frame, a texture frame, a change frame, or any combinations thereof. In embodiments, at least one of a mesh frame, a texture frame, a change frame, or a combination thereof may be encoded or generated based on the requirements of a CODEC format, any video transmission format, or any combinations thereof. Further, a predetermined range may be used to determine the type of frame to encode. The predetermined range may be determined based on the desired image quality, limitations on the size of the resulting 3D video stream, the storage capacity of the computing device, performance, or network bandwidth.

The process flow diagram of FIG. 6 is not intended to indicate that the blocks of method 600 are to be executed in any particular order, or that all of the blocks are to be included in every case. Further, any number of additional blocks may be included within the method 600, depending on the details of the specific implementation. Additionally, while the methods described herein include a camera or image capture mechanism, the mesh and corresponding texture may be encoded using any electronic device.

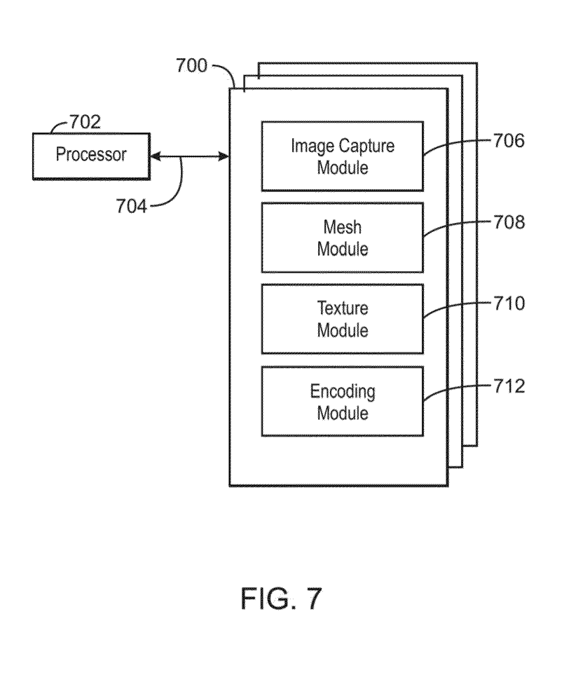

FIG. 7 is a block diagram showing tangible, non-transitory computer-readable media 700 that stores code for encoding images using a mesh and a corresponding texture, in accordance with embodiments. The tangible, non-transitory computer-readable media 700 may be accessed by a processor 702 over a computer bus 704. Furthermore, the tangible, non-transitory computer-readable media 700 may include code configured to direct the processor 702 to perform the methods described herein.

The various software components discussed herein may be stored on the tangible, non-transitory computer-readable media 700, as indicated in FIG. 7. For example, an image capture module 706 may be configured to obtain depth information and image texture information. A mesh module 708 may be configured to calculate the 3D mesh of polygons from the depth information. A texture module 710 may be configured to determine the corresponding textures using the image texture information. Further, an encoding module 712 may be configured to encode the 3D mesh of polygons and the corresponding textures using at least one of a mesh frame, a texture frame, a change frame, or any combinations thereof.

The block diagram of FIG. 7 is not intended to indicate that the tangible, non-transitory computer-readable media 700 is to include all of the components shown in FIG. 7. Further, the tangible, non-transitory computer-readable media 700 may include any number of additional components not shown in FIG. 7, depending on the details of the specific implementation.

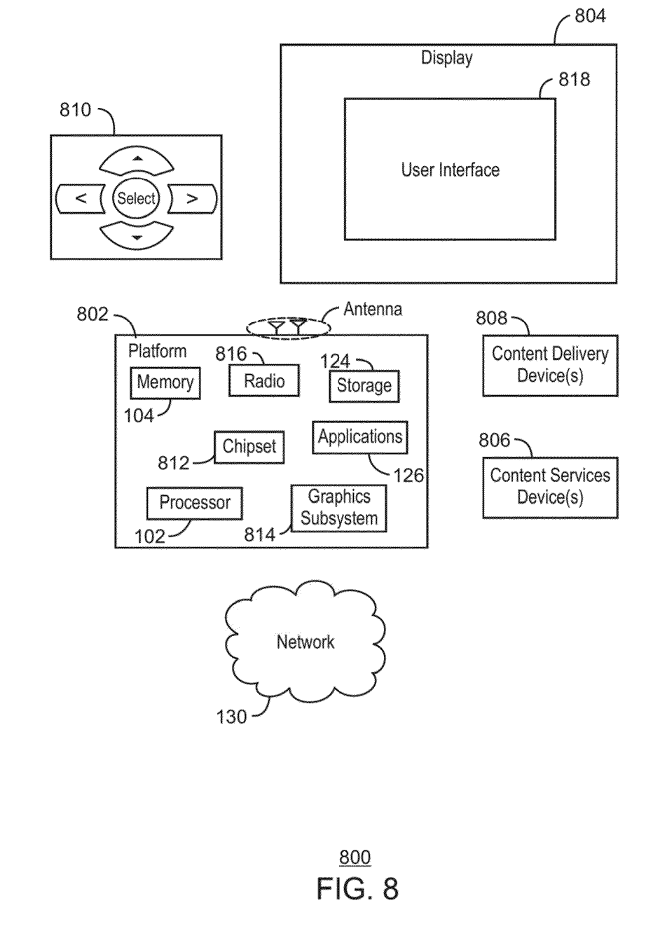

FIG. 8 is a block diagram of an exemplary system 800 for encoding images using a 3D mesh of polygons and corresponding textures, in accordance with embodiments. Like numbered items are as described with respect to FIG. 1. In some embodiments, the system 800 is a media system. In addition, the system 800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, or the like.

In various embodiments, the system 800 comprises a platform 802 coupled to a display 804. The platform 802 may receive content from a content device, such as content services device(s) 806 or content delivery device(s) 808, or other similar content sources. A navigation controller 810 including one or more navigation features may be used to interact with, for example, the platform 802 and/or the display 804. Each of these components is described in more detail below.

The platform 802 may include any combination of a chipset 812, a central processing unit (CPU) 102, a memory device 104, a storage device 124, a graphics subsystem 814, applications 126, and a radio 816. The chipset 812 may provide intercommunication among the CPU 102, the memory device 104, the storage device 124, the graphics subsystem 814, the applications 126, and the radio 814. For example, the chipset 812 may include a storage adapter (not shown) capable of providing intercommunication with the storage device 124.

The CPU 102 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the CPU 102 includes dual-core processor(s), dual-core mobile processor(s), or the like.

The memory device 104 may be implemented as a volatile memory device such as, but not limited to, a Random Access Memory (RAM), Dynamic Random Access Memory (DRAM), or Static RAM (SRAM). The storage device 124 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, the storage device 124 includes technology to increase the storage performance enhanced protection for valuable digital media when multiple hard drives are included, for example.

The graphics subsystem 814 may perform processing of images such as still or video for display. The graphics subsystem 814 may include a graphics processing unit (GPU), such as the GPU 108, or a visual processing unit (VPU), for example. An analog or digital interface may be used to communicatively couple the graphics subsystem 814 and the display 804. For example, the interface may be any of a High-Definition Multimedia Interface, DisplayPort, wireless HDMI, and/or wireless HD compliant techniques. The graphics subsystem 814 may be integrated into the CPU 102 or the chipset 812. Alternatively, the graphics subsystem 814 may be a stand-alone card communicatively coupled to the chipset 812.

The graphics and/or video processing techniques described herein may be implemented in various hardware architectures. For example, graphics and/or video functionality may be integrated within the chipset 812. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 816 ray include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 816 may operate in accordance with one or more applicable standards in any version.

The display 804 may include any television type monitor or display. For example, the display 804 may include a computer display screen, touch screen display, video monitor, television, or the like. The display 804 may be digital and/or analog. In some embodiments, the display 804 is a holographic display. Also, the display 804 may be a transparent surface that may receive a visual projection. Such projections may convey various forms of information, images, objects, or the like. For example, such projections may be a visual overlay for a mobile augmented reality (MAR) application. Under the control of one or more applications 126, the platform 802 may display a user interface 818 on the display 804.

The content services device(s) 806 may be hosted by any national, international, or independent service and, thus, may be accessible to the platform 802 via the Internet, for example. The content services device(s) 806 may be coupled to the platform 802 and/or to the display 804. The platform 802 and/or the content services device(s) 806 may be coupled to a network 130 to communicate (e.g., send and/or receive) media information to and from the network 130. The content delivery device(s) 808 also may be coupled to the platform 802 and/or to the display 804.

The content services device(s) 806 may include a cable television box, personal computer, network, telephone, or Internet-enabled device capable of delivering digital information. In addition, the content services device(s) 806 may include any other similar devices capable of unidirectionally or bidirectionally communicating content between content providers and the platform 802 or the display 804, via the network 130 or directly. It will be appreciated that the content may be communicated unidirectionally and/or bidirectionally to and from any one of the components in the system 800 and a content provider via the network 130. Examples of content may include any media information including, for example, video, music, medical and gaming information, and so forth.

The content services device(s) 806 may receive content such as cable television programming including media information, digital information, or other content. Examples of content providers may include any cable or satellite television or radio or Internet content providers, among others.

in some embodiments, the platform 802 receives control signals from the navigation controller 810, which includes one or more navigation features The navigation features of the navigation controller 810 may be used to interact with the user interface 818, for example. The navigation controller 810 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures, Physical gestures include but are not limited to facial expressions, facial movements, movement of various limbs, body movements, body language or any combinations thereof. Such physical gestures can be recognized and translated into commands or instructions.

Movements of the navigation features of the navigation controller 810 may be echoed on the display 804 by movements of a pointer, cursor, focus ring, or other visual indicators displayed on the display 804. For example, under the control of the applications 126, the navigation features located on the navigation controller 810 may be mapped to virtual navigation features displayed on the user interface 818. In some embodiments, the navigation controller 810 may not be a separate component but, rather, may be integrated into the platform 802 and/or the display 804.

The system 800 may include drivers (not shown) that include technology to enable users to instantly turn on and off the platform 802 with the touch of a button after initial boot-up, when enabled, for example. Program logic may allow the platform 802 to stream content to media adaptors or other content, services device(s) 806 or content delivery device(s) 808 when the platform is turned “off.” In addition, the chipset 812 may include hardware and/or software support for 5.1 surround sound audio and/or high definition 7.1 surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 800 may be integrated. For example, the platform 802 and the content services device(s) 806 may be integrated; the platform 802 and the content delivery device(s) 808 may be integrated; or the platform 802, the content services device(s) 806, and the content delivery device(s) 808 may be integrated. In some embodiments, the platform 802 and the display 804 are an integrated unit. The display 804 and the content service device(s) 806 may be integrated, or the display 804 and the content delivery device(s) 808 may be integrated, for example.

The system 800 may be implemented as a wireless system or a wired system. When implemented as a wireless system, the system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 802 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a predetermined manner. The embodiments, however, are not limited to the elements or the context shown or described in FIG. 8.

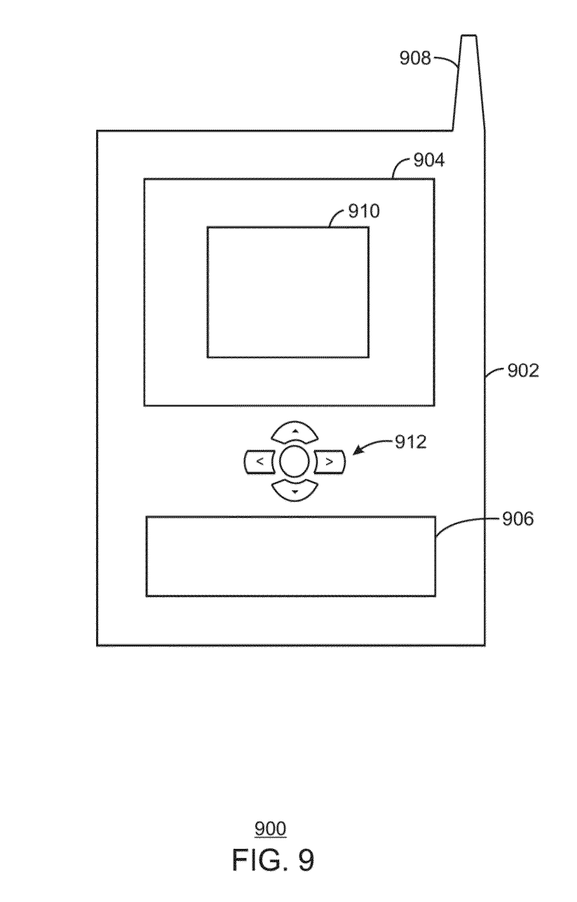

FIG. 9 is a schematic of a small form factor device 900 in which the system 800 of FIG. 8 may be embodied, in accordance with embodiments. Like numbered items are as described with respect to FIG. 8. In some embodiments, for example, the device 900 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well.

As shown in FIG. 9, the device 900 may include a housing 902, a display 904, an input/output (I/O) device 906, and an antenna 908. The device 900 may also include navigation features 910. The display 904 may include any suitable display unit for displaying information appropriate for a mobile computing device. The I/O device 906 may include any suitable I/O device for entering information into a mobile computing device. For example, the I/O device 906 may include an alphanumeric keyboard, a numeric keypad, a touch pad, input keys, buttons, switches, rocker switches, microphones, speakers, a voice recognition device and software, or the like. Information may also be entered into the device 900 by way of microphone. Such information may be digitized by a voice recognition device.

In embodiments, the image capture mechanism may be a camera device that interfaces with a host processor using an interface developed according to specifications by the Mobile Industry Processor Interface (MIPI) Camera Serial Interface (CSI) Alliance. For example, the camera serial interface may be a MIPI CSI-1 Interface, a MIPI CSI-2 Interface, or MIPI CSI-3 Interface. Accordingly, the camera serial interface may be any camera serial interface presently developed or developed in the future. In embodiments, a camera serial interface may include a data transmission interface that is a unidirectional differential serial interface with data and clock signals. Moreover, the camera interface with a host processor may also be any Camera Parallel Interface (CPI) presently developed or developed in the future.

In embodiments, the image capture mechanism may be a component of a mobile computing device. For example, the camera device developed according to MIPI CSI Alliance standards may be an image capture mechanism integrated with at least one or more of the computing device 100 of FIG. 1, the system 800 of FIG. 8, the device 900 of FIG. 9, or any combinations thereof. The image capture mechanism may include various sensors, such as a depth sensor, an image sensor, an infrared sensor, an X-Ray photon counting sensor or any combination thereof. The image sensors may include charge-coupled device (CCD) image sensors, complementary metal-oxide-semiconductor (CMOS) image sensors, system on chip (SOC) image sensors, image sensors with photosensitive thin film transistors, or any combination thereof.

FIG. 10 is a process flow diagram 1000 illustrating a method for printing an image encoded using a 3D mesh of polygons and corresponding textures in a printing device, in accordance with embodiments. The method 1000 can be implemented with a printing device, such as the printing device 134 of FIG. 1. The printing device 134 may include a print object module 136

At block 1002, the print object module 136 can detect an image encoded using a 3D mesh of polygons and corresponding textures. At block 1004, the print object module 136 can alter the encoded mesh and the corresponding textures with at least one of an addition of synthetic images, lighting, shading, object substitution, avatar introduction, or any combinations thereof. In some embodiments, a user can view the image encoded using a 3D mesh of polygons and corresponding textures with the printing device 134, and then alter the image with at least one of an addition of synthetic images, lighting, shading, object substitution, avatar introduction, or any combinations thereof.

At block 1006, the print object module 136 can print the image encoded using a 3D mesh of polygons and corresponding textures. In some embodiments, the print object module 136 may also create multiple views of the image and print the image encoded using a 3D mesh of polygons and corresponding textures. For example, the image may be varied by the colors of the image or the viewing angle of the image.

The process flow diagram of FIG. 10 is not intended to indicate that the steps of the method 1000 are to be executed in any particular order, or that all of the steps of the method 1000 are to be included in every case. Further, any number of additional steps may be included within the method 300, the method 400, the method 600, or any combinations thereof, depending on the specific application. For example, the printing device 134 may render 3D images to a user. Additionally, the print object module 136 may also store the images encoded using a 3D mesh of polygons and corresponding textures.

### Example 1

A method for encoding images using a 3D mesh and corresponding textures is described herein. The method includes obtaining depth information and image texture information. The 3D mesh of polygons may be calculated from the depth information. The corresponding textures may be determined using the image texture information. Additionally, the 3D mesh and the corresponding textures may be encoded using at least one of a mesh frame, a texture frame, a change frame, or any combinations thereof.

The mesh frame may include depth information from an image capture mechanism such as a stereo camera, time of flight sensor, depth sensor, structured light camera, a radial image, a 2D camera time sequence of images computed to create a multi-view stereo reconstruction, or any combinations thereof. The texture frame includes at least one of a texture coordinate, texture information, image texture information, or any combinations thereof. Further, the change frame includes partial mesh frame information, partial texture frame information, or any combinations thereof. The method may also include combining the encoded the 3D mesh of polygons and the corresponding textures with a 3D synthetic graphics object and rendering the combined the 3D mesh of polygons and the corresponding textures and the 3D synthetic graphics object. Additionally, the encoded 3D mesh of polygons and the corresponding textures may be altered with at least one of an addition of synthetic images, lighting, shading, object substitution, avatar introduction, or any combinations thereof. The encoded mesh and the corresponding texture may also be standardized in any CODEC format, any video transmission format, or any combinations thereof.

### Example 2

A computing device is described herein. The computing device includes a central processing unit (CPU) that is configured to execute stored instructions and a storage device that stores instructions. The storage device includes processor executable code that, when executed by the CPU, is configured to gather depth information and image texture information. A 3D mesh of polygons may be computed from the depth information. A corresponding texture may be determined from the image texture information, and an encoded video stream may be generated that specifies the 3D mesh and the corresponding textures via at least one of a mesh frame, a texture frame, a change frame, or any combinations thereof.

The 3D mesh frame may include depth information from an image capture mechanism such as a stereo camera, time of flight sensor, depth sensor, structured light camera, a radial image, a 2D camera time sequence of images computed to create a multi-view stereo reconstruction, or any combinations thereof. The texture frame may include at least one of a texture coordinate, texture information, image texture information, or any combinations thereof. Further, the change frame may include partial mesh frame information, partial texture frame information, or any combinations thereof. Additionally, the central processing unit or a graphics processing unit may combine the encoded video stream with a 3D synthetic graphics object, and render the combination of the encoded video stream and the 3D synthetic graphics object. The central processing unit or a graphics processing unit may also alter the encoded video stream with at least one of an addition of synthetic images, lighting, shading, object substitution, avatar introduction, or any combinations thereof. Furthermore, the encoded video stream may be standardized in any CODEC format, any video transmission format, or any combinations thereof. The computing device may also include a radio and a display, the radio and display communicatively coupled at least to the central processing unit.

### Example 3

At least one non-transitory machine readable medium having instructions stored therein is described herein. In response to being executed on a computing device, the instructions cause the computing device to obtain depth information and image texture information. A 3D mesh of polygons may be calculated from the depth information, and the corresponding textures may be determined using the image texture information. The 3D mesh and the corresponding textures may be encoded using at least one of a mesh frame, a texture frame, a change frame, or any combinations thereof.

The mesh frame may include depth information from an image capture mechanism such as a stereo camera, time of flight sensor, depth sensor, structured light camera, a radial image, a 2D camera time sequence of images computed to create a multi-view stereo reconstruction, or any combinations thereof. The texture frame includes at least one of a texture coordinate, texture information, image texture information, or any combinations thereof. Further, the change frame includes partial mesh frame information, partial texture frame information, or any combinations thereof. The instructions may also include combining the encoded the 3D mesh of polygons and the corresponding textures with a 3D synthetic graphics object, and rendering the combined the 3D mesh of polygons and the corresponding textures with the 3D synthetic graphics object. Additionally, the encoded 3D mesh of polygons and the corresponding textures may be altered with at least one of an addition of synthetic images, lighting, shading, object substitution, avatar introduction, or any combinations thereof. The encoded mesh and the corresponding textures may also be standardized in any CODEC format, any video transmission format, or any combinations thereof.

### Example 4

A computing device is described herein. The computing device includes a host processor that is configured to execute stored instructions, wherein the host processor interfaces with an image capture mechanism using a camera serial interface. The host processor is configured to gather depth information and image texture information. The host processor is also configured to compute a 3D mesh of polygons from the depth information. Further, the host processor is configured to determine a corresponding texture from the image texture information and generate an encoded video stream that specifies the 3D mesh of polygons and the corresponding textures via at least one of a mesh frame, a texture frame, a change frame, or any combinations thereof. The camera serial interface includes a data transmission interface that is a unidirectional differential serial interface with data and clock signals. The image capture mechanism may also includes a depth sensor, an image sensor, an infrared sensor, an X-Ray photon counting sensor, a charge-coupled device (CCD) image sensor, a complementary metal-oxide-semiconductor (CMOS) image sensor, a system on chip (SOC) image sensor, an image sensors with photosensitive thin film transistors, or any combination thereof.

### Example 5

A printing device to print an image encoded using a 3D mesh of polygons and corresponding textures in a printing device is described herein. The printing device includes a print object module configured to detect an image encoded using a 3D mesh of polygons and corresponding textures and alter the image with at least one of an addition of synthetic images, lighting, shading, object substitution, avatar introduction, or any combinations thereof. The print object module may also print the image encoded using a 3D mesh of polygons and corresponding textures. Further, the print object module can print multiple views of the image.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method for encoding images using a 3D mesh of polygons and corresponding textures, comprising:
obtaining depth information and image texture information;
calculating the 3D mesh of polygons from the depth information;
determining the corresponding textures using the image texture information; and
encoding the 3D mesh of polygons and the corresponding textures using at least one of a mesh frame, a texture frame, a change frame, or any combinations thereof.

2. The method of claim 1, wherein the mesh frame includes depth information from an image capture mechanism such as a stereo camera, time of flight sensor, depth sensor, structured light camera, a radial image, a 2D camera time sequence of images computed to create a multi-view stereo reconstruction, or any combinations thereof.

3. The method of claim 1, wherein the texture frame includes at least one of a texture coordinate, texture information, image texture information, or any combinations thereof.

4. The method of claim 1, wherein the change frame includes partial mesh frame information, partial texture frame information, or any combinations thereof.

5. The method of claim 1, further comprising:
combining the encoded 3D mesh of polygons and the corresponding textures with a 3D synthetic graphics object; and
rendering the combined encoded 3D mesh of polygons and the corresponding textures with the 3D synthetic graphics object.

6. The method of claim 1, wherein the encoded 3D mesh of polygons and the corresponding textures are altered with at least one of an addition of synthetic images, lighting, shading, object substitution, avatar introduction, or any combinations thereof.

7. The method of claim 1, wherein the encoded 3D mesh of polygons and the corresponding textures are standardized in any CODEC format, any video transmission format, or any combinations thereof.

8. A computing device, comprising:
a central processing unit (CPU) that is configured to execute stored instructions;
a storage device that stores instructions, the storage device comprising processor executable code that, when executed by the CPU, is configured to:
gather depth information and image texture information;
compute a 3D mesh of polygons from the depth information;
determine a corresponding texture from the image texture information; and
generate an encoded video stream that specifies the 3D mesh of polygons and the corresponding textures via at least one of a mesh frame, a texture frame, a change frame, or any combinations thereof.

9. The computing device of claim 8, wherein the mesh frame includes depth information from an image capture mechanism such as a stereo camera, time of flight sensor, depth sensor, structured light camera, a radial image, a 2D camera time sequence of images computed to create a multi-view stereo reconstruction, or any combinations thereof.

10. The computing device of claim 8, wherein the texture frame includes at least one of a texture coordinate, texture information, image texture information, or any combinations thereof.

11. The computing device of claim 8, wherein the change frame includes partial mesh frame information, partial texture frame information, or any combinations thereof.

12. The computing device of claim 8, wherein the central processing unit or a graphics processing unit combines the encoded video stream with a 3D synthetic graphics object, and renders the combination of the encoded video stream and the 3D synthetic graphics object.

13. The computing device of claim 8, wherein the central processing unit or a graphics processing unit alters the encoded video stream with at least one of an addition of synthetic images, lighting, shading, object substitution, avatar introduction, or any combinations thereof.

14. The computing device of claim 8, wherein the encoded video stream is standardized in any CODEC format, any video transmission format, or any combinations thereof.

15. The computing device of claim 8, further comprising a radio and a display, the radio and display communicatively coupled at least to the central processing unit.

16. At least one machine readable medium having instructions stored therein that, in response to being executed on a computing device, cause the computing device to:
obtain depth information and image texture information;
calculate a 3D mesh of polygons from the depth information;
determine corresponding textures using the image texture information; and
encode the 3D mesh of polygons and the corresponding textures using at least one of a mesh frame, a texture frame, a change frame, or any combinations thereof.

17. The at least one machine readable, medium of claim 16, wherein the mesh frame ncludes depth information from an image capture mechanism such as a stereo camera, time of flight sensor, depth sensor, structured light camera, a radial image, a 2D camera time sequence of images computed to create a multi-view stereo reconstruction, or any combinations thereof.

18. The at least one machine readable medium of claim 16, wherein the texture frame includes at least one, of a texture coordinate, texture information, image texture information, or any combinations thereof.

19. The at least one machine readable medium of claim 16, wherein the change frame includes partial mesh frame information, partial texture frame information, or any combinations thereof.

20. The at least one machine readable medium of claim 16, further comprising instructions stored therein that, in response to being executed on the computing device, cause the computing device to
combine the encoded 3D mesh of polygons and the corresponding textures with a 3D synthetic graphics object; and
render the combined 3D mesh of polygons and the corresponding textures with the 3D synthetic graphics object.

21. The at least one machine readable medium of claim 16, wherein the encoded 3D mesh of polygons and the corresponding textures are altered with at least one of an addition of synthetic images, lighting, shading, object substitution, avatar introduction, or any combinations thereof.

22. The at least one machine readable medium of claim 16, wherein the encoded 3D mesh of polygons and the corresponding textures are standardized in any CODEC format, any video transmission format, or any combinations thereof.

23. A computing device, comprising:
a host processor that is configured to execute stored instructions, wherein the host processor interfaces with an image capture mechanism using a camera serial interface and is configured to:
gather depth information and image texture information;
compute a 3D mesh of polygons from the depth information;
determine a corresponding texture from the image texture information; and
generate an encoded video stream that specifies the 3D mesh of polygons and the corresponding textures via at least one of a mesh frame, a texture frame, a change frame, or any combinations thereof.

24. The computing device of claim 23, wherein the camera serial interface includes a data transmission interface that is a unidirectional differential serial interface with data and clock signals.

25. The computing device of claim 23, wherein the image capture mechanism includes a depth sensor, an image sensor, an infrared sensor, an X-Ray photon counting sensor, a charge-coupled device (CCD) image sensor, a complementary metal-oxide-semiconductor (CMOS) image sensor, a system on chip (SOC) image sensor, an image sensors with photosensitive thin film transistors, or any combination thereof.

26. A printing device to print an image encoded using a 3D mesh of polygons and corresponding textures in a printing device, comprising a print object module configured to:
detect an image encoded using a 3D mesh of polygons and corresponding textures;
alter the image with at least one of an addition of synthetic images, lighting, shading, object substitution, avatar introduction, or any combinations thereof; and
print the image encoded using a 3D mesh of polygons and corresponding textures.

27. The printing device of claim 26, wherein the print object module prints multiple views of the image.
